(19) United States
(12) Patent Application Publication
(10) Pub. No.: US 2006/0180361 A1
(43) Pub. Date: Aug. 17, 2006

(54) Eleqtrogine

(76) Inventor: Louis Montalbo, Fair Oaks, CA (US)

Correspondence Address: Louis Montalbo, Sr., 6625 Oakbrook Drive, Fair Oaks, CA, 95628, US

(21) Appl. No.: 11/059,090

(22) Filed: Feb. 16, 2005

(51) Int. Cl. B60K 1/00

(52) U.S. Cl. 180/65.1

(57) ABSTRACT

The New Eleqtrogine Self-Contained Electrical Power System (S.C.E.P.S.) is designed for electrical vehicles and other applications. This new system provides electricity to a motor, the motor produces mechanical energy. This mechanical energy is applied to the automatic transmission by centralized controls and delivered by the Operator throttle, while the system is synchronized at 800 RPM. The New Eleqtrogine is a unique dynamotor that has characteristics of an IC engine and the performance in Torque and cruising speed. Thus mimicking the I.C. engine, with all it's electrical dynamo. The actual starting of the system was accomplished by a heavy duty starter motor energized by one 12V DC battery, F-3. Key component to the whole system requires some recharging. Electrical energy systems: self-contained, designed for Electric Vehicles and other applications, providing kinetical energy from a combination of electric motors, generators, belts, and pulleys mounted in a triangular configuration arranged to give an appearance of an automobile engine. This unique electric motor has the characteristics of an internal combustion engine, idling at 1200 RPMs. Programmed with timers, sensors, and circuit breakers.

The initial starting is accomplished by the 12-Volt battery (F-3) to start the main motors and generators to make electricity on its own. Thus putting all in phase. Pre-programmed to idle at 1.2K RPMs. At this point, the combined component synergized to run as one motor power system controlled by a centralized on-board computer system programmed to the driver control.

### DESCRIPTION FOR THE PREFERRED EMBODIMENT

The embodiment of said invention will now be described with reference to the accompanying drawing.

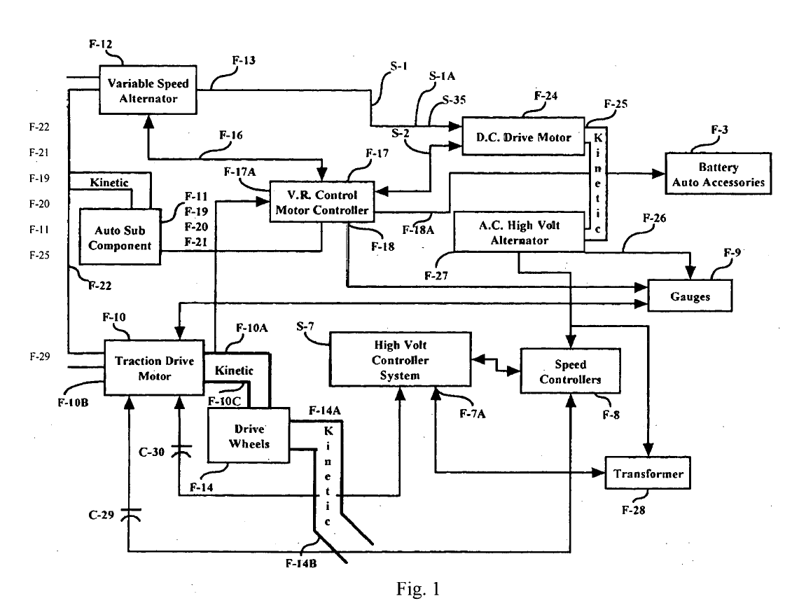

THE NEW ELEQTROGINE means an integrated S.C.E.P.S. A combination of DC motors, batteries, DC generators, AC motors, AC alternators, as well as transformers, voltage combined regulators, breakers, timers, sensors, and appropriate cabling circuitries. “Referring now to the accompanying drawing, a description will be given of the preferred embodiment of the present invention: Component, some data information will be given in carrying this invention to a conclusion. Starting with FIG. 1, a self-contained electrical system for powering vehicles have a propulsion motor F-10 an AC three phase induction motor with a capacity of 385 V, 186 A, 72 KW=96 HP of kinetical energy connected by F-22 fan belts and F-12. Coupled to the F-14 transmission that power F-14A coupled connected F-14B. This power plant F-10 is the last component to come on-line. After the initial start F-3 stored energy (battery) 12-V connected for high current delivery to F-10-A.

FIG. 1 a S.C.E.P.S.: for a F-10 an AC three phase, 4.0 wire induction motor vehicle propulsion system utilizing an electrically operated power plant comprising of an electric AC alternator F-27 coupled by means of a F-25 fan belt and pulleys F-26 connecting to the advance D.C. F.B.I.-4001 model series DC motor F-24 20 HP with a 70 HP peak (test data by manufacturer for F.B.I. 4001, F-24) 75 V—0.003 running continuous, 690V—210 A RPM 2.8 K RPM, 17.0 HP 128 KW F-24 provide driving power to F-27, provide electricity to S-7 high volt motor controlling circuit S-7B, delivers to F-8 speed controller vehicle-speed data, to controller S-7 back to F-28 transformer to S-7 constituted by a switching circuit. A description of the details of its structure will be omitted since the circuitry is conventionally well-known to the industry. NOTE: all components are the same as you would use for any or most battery operated vehicles, with the exception of none battery operating system—such as the New Eleqtrogine.

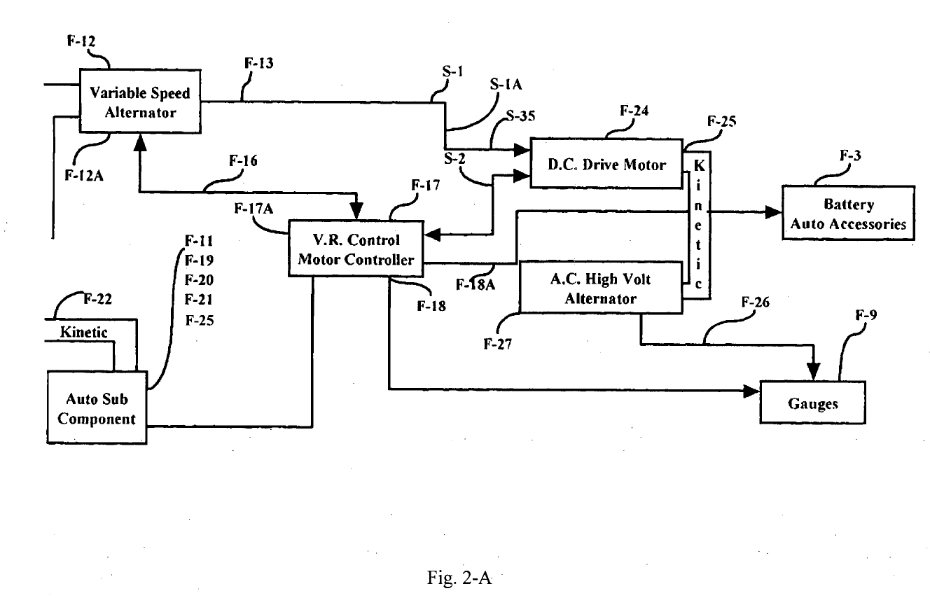

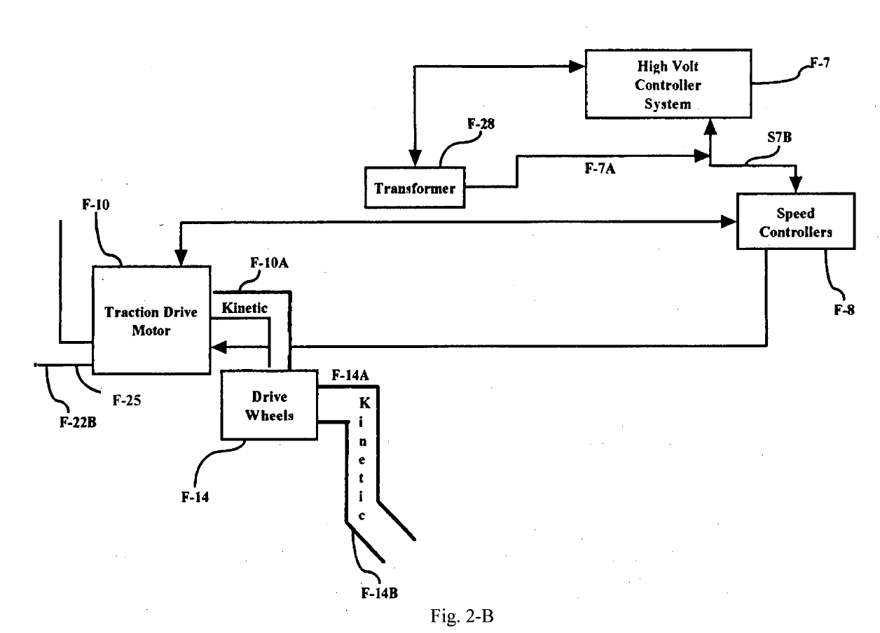

F-10 exclusively driving the wheels of F-14B sending energy back to FIG. 2-A by means of kinetical energy. This energy is provided by F-10 delivered by means of F-22 connected on both ends. F-12 directly to F-10 at a continuous 1.2K RPM pre-programmed by S-7. Thus leaving a surplus RPM of 10.8K RPM driving the vehicle. The throttle control F-8 connected to FIG. 2B to F-10. The variable speed alternator is calibrated for variable speed F-12. This alternator F-12 connected directly to F-17A voltage regulator in combination reverse current cutout relay. Often a variable speed DC generator F-12 utilized in combination with a storage battery F-3 to supply power to F-10-A when the generator F-12 speeds, and therefore the output voltage F-12 is low. The battery F-3 supplies power to the F-10-A and when the DC generator F-12 comes up to speed and reaches its rated output, it supplies the power to the DC motor F-24 and at the same time recharges the battery F-3 in this arrangement. F-3 cuts out, leaving F-10 to carry F-12-F-24, F-27 AC480V. Convert 480V into mechanical energy, repeating this process.

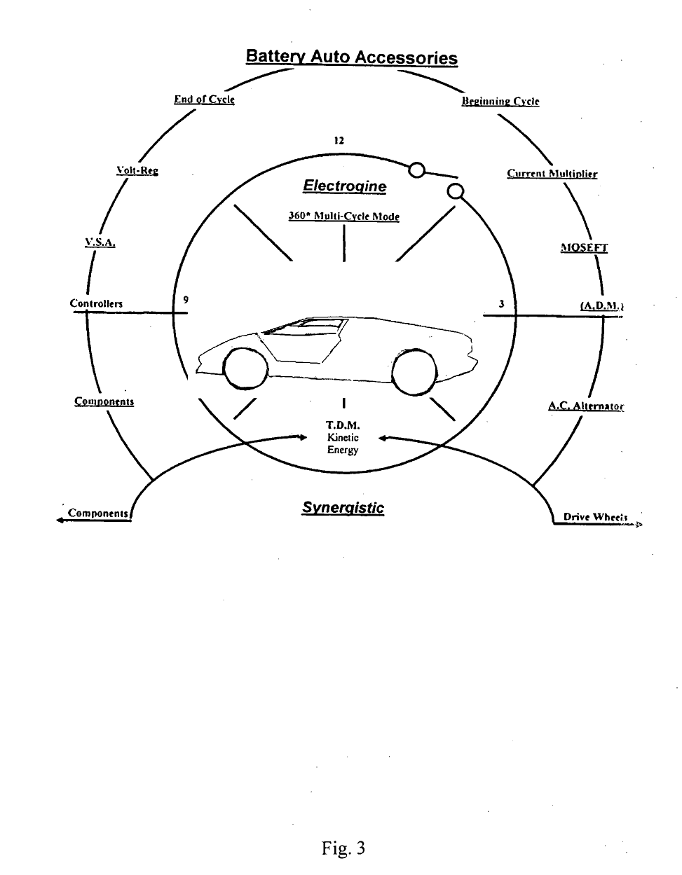

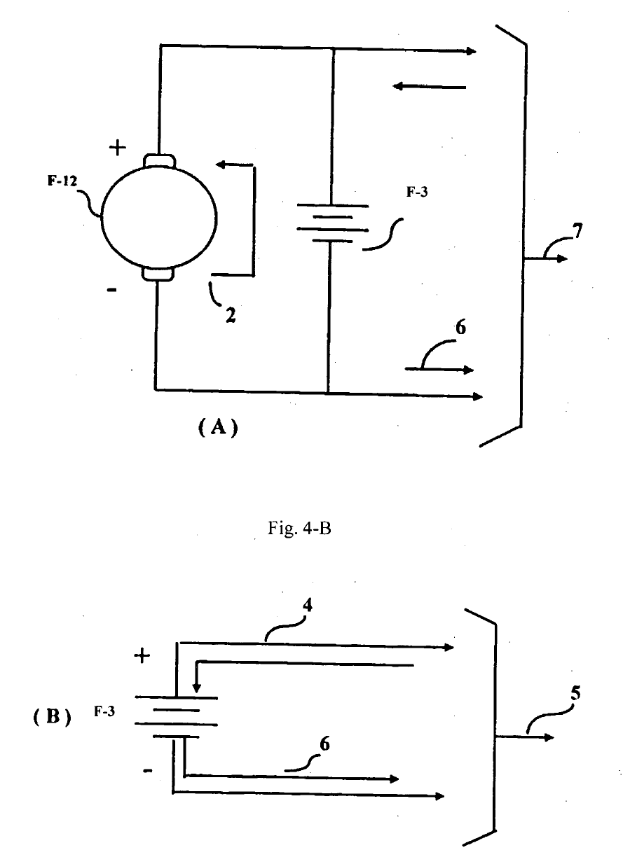

Though, some method must be utilized to disconnect the generator F-12 from the battery F-3 whenever the generator F-12 voltage is less than the battery F-3. Otherwise, the batteries would discharge through generator armature winding and possibly burn it out. A frequently used method for automatically disconnected the generator F-12 from the batter F-3 makes use of a reverse-current cutout relay shown in FIG. 4. A typical circuit is shown in FIG. 4. Reverse current output relay connects the generator F-12 output to the battery F-3 and the DC motor F-24 when the DC generator F-12 voltage is greater than the battery F-3 voltage, it disconnects the generator F-12 from the battery F-3 and the DC motor F-10-A when the generator V-drops F-12 below that of the battery F-3 S-7 high voltage AC an enhanced I.G.B.T. (Insulated Gate Bipolar Transistor) uses a cell design similar to a MOSFET.

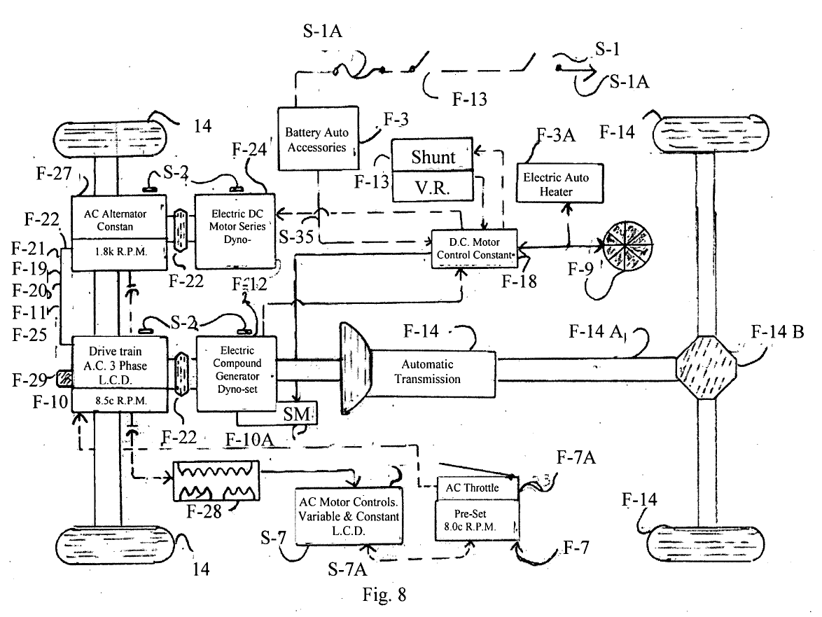

FIG. 8. The I.G.B.T. S-7 is specifically designed for the Electric Vehicle market and extends its capability to include handling high in rush current during acceleration and lower steady state loses at cruise. The E.V. application requires high volt, high current and high frequency. (Typically 15-20 K Hz) the newest I.G.B.T. device compared very well with more traditional solid-state power device, offering low voltage drop (minimum power consumption) fast switching time (high frequency operation) and lower gate voltage drive S-7. The AC induction motor F-10 provide driving power to the transmission F-14 and to the wheels F-14B, and the transformer F-28. The entire technology depends on transformer designed for E.V.s are more efficient (typically 98-99%) and they rarely wear out because they have no moving parts. (Increasing the frequency means a reduction in size.) A fact that holds equally true for motors. Vital importance to E.V.s. The ideal transformer turn ration “transforms” voltage, current or impedance. Power in +E.I. Power out=E₂I₂. The starting capacitor (C-29-C-30 shown). (Optional) AC alternator 350V F-27 which has peak value, 2 time of that stated earlier has the capacity to generate an output of 480V max.

The shunt is connected in Series F-13 between the variable speed alternator F-12 and the battery F-3. The main circuit breaker S-1 and fuse to switch the heavy currents S-1A the main contactors single pole S-35 heavy duty typically rated t 300 to 900+continuous allow you to control heavy currents with low level voltage F-13. The rheostat current limiter F-18 in a higher power circuit 10K OHMs one Amp fus F-18A. The gauges for both systems F-9, the charge guard has a series of 9 leads on its display: 5 green, 2 yellow and 2 red when the vehicle battery pack F-3 is fully charged. Shown F-9 the AC voltmeter 0-500 V F-AC.10A and AC AM meter 0-500 AF F-10. The DC voltmeter 0-250 V F-DC F-9, and the DC AM meter 300-900 A F-DC. F-9, typical instrument to monitor the input and output F-9.

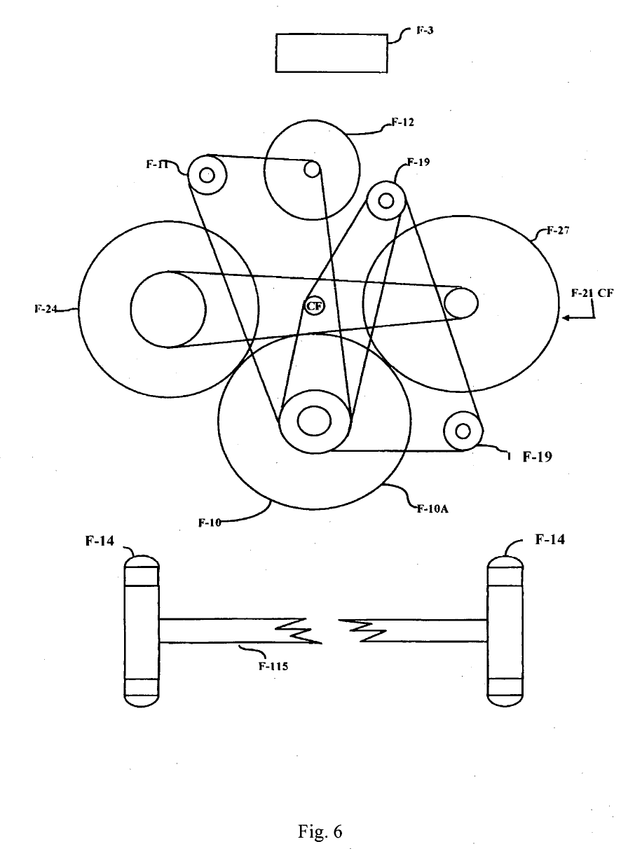

FIG. 6—The automobile subcomponent the cooling fan F-21CF and power steering F-19 and air conditioner unit F-20 and power brakes F-11. 12-V F-3 as described earlier.

The New Eleqtrogine can be assembled into a triangle one unit motor. Constructed outside the vehicle to look like an IC engine by mounting all of these motors, generators, AC compressors, power steering, power brakes, fans and blowers, fan belts, and pulleys, put together to make a single electric motor. To start the integrated electrical system, you need F-3 −12-V 210 Amps. The AC induction F-10 motor has a front and rear shaft the same as for an. IC engine. F-10A and F-10B to start the new Eleqtrogine F-10 turn key (not shown) in circuit near S-1 the integrated motor system. Will run at 800 RPM in an idling mode. F-24 programmed at a constant output F-27, 1.2K RPM minimum.

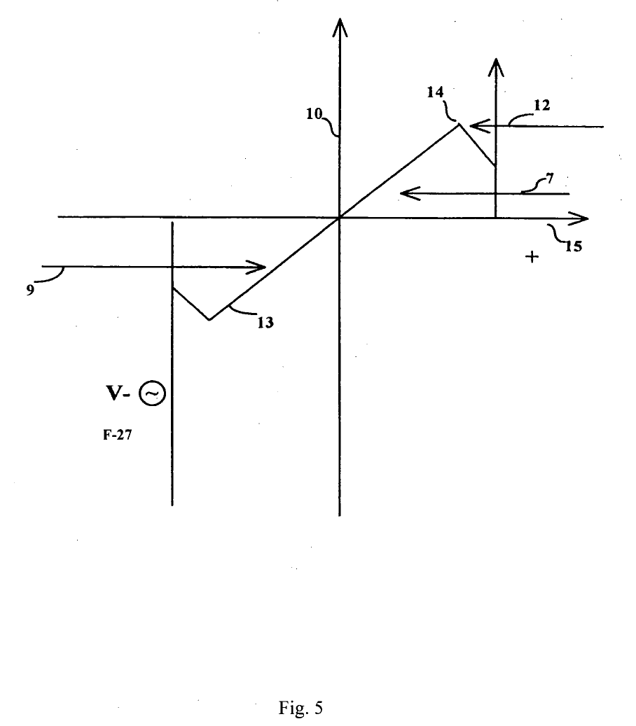

FIG. 5-Polyphase AC motors unique speed and torque 10 on chart FIG. 5 and slip characteristic vs. voltage and frequency 9 and 12, and generator action: 13 and the motor action: 14 with the peak torque 12 and shows the starting torque 7 and at a full load torque 15 and shows the negative pole 1, positive pole 2 not shown, and the slip torque varies with slip at any given voltage and frequency max torque can be maintained if voltage to frequency ratio are held constant 8. The induction motor must lag a few RPMs behind the rotating field, even at no load to overcome retarding effect of motor losses. The controller I.G.B.T. output impedance must match motor input impedance for max power transfer FIG. 5. This is important. The output torque of the induction motor is given by (28) Tout=(3 R₂×# of Poles×V²)/(4++fs (R1+(R2/S))²+(2++F)² (1.+L2)²)). This impressive looking equation, also derived from the model of FIG. 1-F10 says that at any given voltage and frequency, torque varies with the slip. Substituting for the value of S at maximum torque and using the fact that 2++(L1+l2)>>R1 at higher frequencies. FIG. 5 (29) Tmax=(3×# of poles×V²)(4(2++f)²(L1+L2)). This important equation means that if the voltage to frequency ratio (V/f) can be held constant. FIG. 5., then maximum torque can be maintained throughout the range. Solid state induction motor controllers make use of this vital fact, as you will see in FIG. 5.

The characteristic induction motor torque to slip graph, shown in FIG. 5, both its motor and generator operating regions, offer insight into induction motor operation. If an induction is started at no load, it quickly comes up to a speed that might only be a fraction of one percent less than its synchronous speed. When a load is applied, speed decreases, thereby increases slip; an increased torque is generated to meet the load up to the area of full load torque, and far beyond it up to the maximum torque point (a maximum torque of 350% rated torque is typical). When an induction motor is first started, slip=1.0 and if operating at a higher frequency such at 2++f(L1+L2)>>(R₁+R₂) the starting torque is (30) Tstart=(3Rx×# of poles×V²)(2(2++f)³(L1+L2)). This value is also higher than full load torque, and is actually specified by N.E.M.A. (National Electrical Manufacturers Association) at values from 150% to 105% for 60 Hz Squirrel Cage Induction Motors of 2-16 poles, respectively. N.E.M.A. also categorizes squirrel cage induction motors into classes A through F, based on their slip, starting and running torque, and current characteristics. Induction motor how much regenerative break you apply creates braking (moves the steady state induction motor operating point down the torque-slip curve) and generates power (instantaneously runs with negative slip in the generator region supplying power back to the source) Best E.V. Motor Solution FIG. 1.-F-10. Requires some recharging. FIG. 6. Belt or chain driven or hydraulic component F.19.

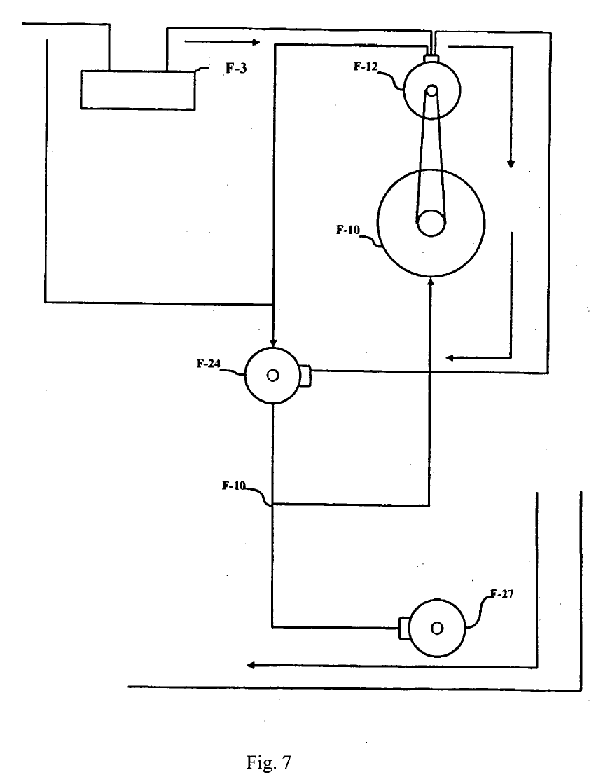

FIG. 7 F-3 12-V, 400 Amp carrying the load. When load becomes under pressure, the voltage drops. Current increases. The max load to output is 20-30-Hp with a peak power of 60 Hp. The “state the system inductance”><change in the current F-24 is the prime mover. Converting F-3 into kinetic energy output horsepower (Hp) is a unit of power and numerically, 1 Hp=33.K ft-lb per minute or 55-ft-lb per second. (Example: losses are listed here illustrate why 100 Hp is not received from an electrical motor with 74,600 watts input. A 100 Hp DC motor at 250 volts draws 341 amperes. Since P=E/1 therefore P=250×341=85,250 watts. Now 114 Hp=74,600 watts. So there is a loss of 7.240 watts. The efficiency of the DC motor is output/input−74,600 watts/81,840 watts=91,1590. (Based on a 114 Hp 250 V=341 A).

FIG. 8. F-27 requires 20 Hp and with this systems has a backup of 22 Hp. This unit has an output AC 480 V 140A max. F-27 can deliver by F-10 AC induction motor. Constant 300V 180A programmed not to vary more or less 3% tolerance and can be event tightened more. F-17 connected to the transformer to the I.G.B.T. current limit sensor an adjustment. The MC33033 PWM IC also allows you to design current limiting adjustments. Protection and thermal compensation into the controller. In this design, the I.G.B.T. on voltage plus diode drop varies from 1.5 volts to 3.5 volts—corresponding to moor currents of 300 Amps and 500 Amps in this box corresponding 1.6 volts and 3.6 volts input levels are delivered to a comparator whose trip point—again disabling the output if current levels are exceeded, is set by its own reference voltage input level. This system is a synergistic newly applied electrical technology. Must be disciplined by its values and output: input as well.

The low voltage high current circuit FIG. 7 simplifying the circuits path starting with F-3 to F-10-A mover of F-27 to F-10 connected by fan belt or mechanically coupled to variable speed alternator F-12 in turn F-12 250V 210 Amp connects to F-3 and F-24 on FIG. 7.

After starting F-3, F-10-A takes over the electrical output from F-3 disconnected by voltage regulator reverse cutout F-3. Taken over by F-12 shown in FIG. 8.

This portion of the system runs continuously F-24 at 2000 RPM, output hours-power 20 Hp with a peak Hp of 70 Hp. Preprogrammed prototype shows when all components are in-sync at 800 RPM idling mode and power demand is applied by the LCD (lowest common denominator)=F-10 the demand on F-10 is in complete control after the disconnect from F-15 accomplished. F-10 will hold its command and power to all system. F-10 moves every part of the system while its contributing to its needs of energy that is addressed by the operator of the vehicle.

F-10 drive train is also supportive of all of automobile sub-components carried out by an adaptable drive train shaft F-29.

The New Eleqtrogine Electrical System and the method and know how to synergistically produce electricity and mechanical energy to appropriate vehicle and other applications as well. The whole system is comprised of five major components.

FIG. 1-#1-F-27. A.C. Alternator 0-480 ACVA constantly at 800 RPM driven by F-24. F-24 DCV 30 Hp with a spike of 70 Hp speed control VR and synchronized for top performance.

F-12 D.C. 2.5 CV generator controlled and regulated and connected by F-17 VR Controls to F-24 D.C. Drive Motor Spike 210. DC volt-amps, F-17 controlled, F-10 A.C. propulsion motor tuned to run at 800 RPM+-−synchronize. F-10a starter key to F-3 12 volt D.C. Battery connected to controls key: starter motor connected to motor and fly wheel.

When F-3 turn motor over the work begins on all components and controlled by the throttle, in a synergistic controlled operation.

F-27, FIG. 8 Alternator dynamically balanced rotor winding impregnated with 100% solid epoxy resin for excellent cooling and complete environmental protection manufacture specifications. Continuous speed 1.8K RPM.

F-24 Converter Motor DC=Mechanical energy drives an AC Alternator F-27 1.8K RPM 0-480 VA250AC Amps. 480×0.8 Pf=384 AC VA 250×0.8 Pf=200 Amps.

F-12 Compound Generator: D.C. Electrical energy. A combination of a series generator and a shunt generator. The series winding aid in maintaining constant voltage with variable current output. As the load goes up, more current goes through the series field winding and raises the voltage to take care of the voltage drop.

F-24 DC Converter Motor Generator: Impressed voltage (l.e.m.f.).

FIG. 1 Capacitors: F-10, 3 Phase Motor Capacitors located ahead of motor thermal overload protection capacitors connected ahead of all motor loads. This could be at the service head, capacitors are required to be fused and have resistors across their terminals to bleed the charge of the capacitor away to keep from giving shocks. When the capacity is connected at the F-10 3 phase motor, the motor will also assist in bleeding off the charge.

FIG. 8, F-27-F-12 Softy Heat Sensors (S-2) as well F-10 and (S-2) all heat censored. Also has an auto heater F-3A controlled by F-18.

### OPERATION OF THE ELECQTROGINE MOTOR & BEST MODE

The technique is the idling of F-10 LCD to its lowest, which is 8.5c RPMs+/−. At this juncture, all of the components (F-24; F-27; F-12 LCD; and F-8 speed controllers) are running and synchronized. When F-8 is applied to move the vehicle, the F-10 RPMs increase all of the other components. F-24, F-27 and F-12 increase as well, exceeding that of its counterparts. Simple and efficient F-8 controllers speed and power the New Eleqtrogine S.C.E.P.S. That mimics a gasoline engine to the extent as described above as well as a perpetual motion theory.

Other components addressed: Options: Auxiliary relay 5-7 not shown. (Typical) transformer. F-28. Step up, step down S.U. 500KVA, S.D. 350 VA AC to 12 V DC and 250 DC. Not shown in FIG. 1. F-28 connected to FIG. 1 5-7 1.G. B.T. can relieve or replace F-24 with input 250 V DC. The potential of this newly applied electrical is not without its problems that have to be addressed as the system progresses and brought and tuned to its full potential. For the manufacturer, it has lots of options open to exploit this new system. Many components can be added or replaced for better performance in all areas. There's energy to be utilized and controlled.

FIG. 8. Electromagnetic Induction with a coil, D.C. Shunt-Motor regulation. A series motor varies widely in speed with variation in the load. The motor's field strength varies with the load as the armature current will vary with the load, and the armature and field are in series, so they both receive the same current. Also, the combined resistance of the field and armature is higher than the resistance of the armature of a shunt motor in FIG. 8. Assume a speed of 1400 R.P.M. at a given load. Line AC is line voltage of 100 volts, and CB is counter e.m.f. of 90 volts. So the effective e.m.f. will be 0 volts. Assume that the armature and field resistance are 1.0 ohm. Under these conditions, I=E/R=10/1=10 Amperes. The motor load is increased, so the armature slows down a little. The torque demand of the load has doubled. If the field strength were constant as with a shunt motor, the armature current would have to double. Since an increase in armature current in a series motor also increase the current in the field to the same value. To get double torque the current only needs to increase about 40% if the field current and the armature current are 10 amperes in the shunt motor at a certain torque. The produced torque is proportional to 10×10=100. If the load doubled, the field would still be 10 amperes, so the current in the armature would have to double to 20 amperes. Then 10×20=200, which would be the measure of the torque required for double the load. (D.C. Series-Motor Regulation). Noting the above, with the Series-Motor a 40% increase in current was required to get double torque for the doubled load. Remember that the field current also increased by 40%. Thus, in FIG. 8 with double load the field current would be 14.1 amperes and the armature current would also be 14.1 amperes. Then 14.1×14.1=200, the required torque for double the load.

F-8, S-7 Computerized Controller. Harnessing the Eleqtrogine electrical power: The Eleqtrogine System is started by a D.C. 12 volts battery. Begins when F-10A Starter Motor is energized turning over mechanically the compound .C. Generator F-12. Rated at 250 DCV excited and 200 amperes at a 1200 to 1500 RPM activating about 180 DCV and 105 Amperes=25 Hp. directly into F-24=+/−49% of Hp. F-3 has brought the system F-12 through F-24 close to 50% spike, F-24 now is engaged locked in mechanically to F-27 0-480 ACVA using about 50% of magnetically charged ACVA capacitor starts directed to the Dynamo Induction 3 Phase 60 Hertz 97 Hp. about 65% Pf. (F-10). When F-10 comes on line the computer control continues to fast track. Now it releases F-10A Starter Motor and F-3. Thus, taking over by harnessing the ongoing system synergistically. Now F-8, S-7A, 7B, F-28 are officially online and in synchronous and under the control of the driver. Remember that the harnessing of the system takes place when F-10 comes online, after going off the fast track. The fast track component comes on before F-10. F-10 triggers the harnessing cycle.

FIG. 8. The F-3 is crucial to the New Eleqtrogine as the recharging is to F-3, because it is the only outside energy that Eleqtrogine will need to get started. (F-3 the batter is one of the most important power sources in use today because it's energy is “self-contained.” This is one advantage that none of the other power sources have. All the power sources must first be supplied with outside energy, such as heat, light or mechanical energy, before they can produce electricity. However, the electrical energy of the batter is produced by the chemical energy contained within the battery F-3. Eleqtrogine (S.C.E.P.S.).

Combined Regulation. Frequently, a voltage and current regulator, as well as a reverse current cut-out relay, are all used together to control the output of a variable speed generator. When this is done, all three are usually built and installed as a single unit. Actually, this is the unit called the voltage regulator in an automobile. It really consists of a voltage regulator, a current regulator, and a reverse current cut-out relay, FIG. 4A-B.

Building an Eleqtrogine for E.V. Conversions Lite vehicles, heavy vehicles and pickup trucks under 2 tons: whole kit ready to install with transmission adaptors connecting mechanically to transmission of vehicles. Balanced to avoid vibrations at the motor mounts, and elsewhere, kit includes engine room motor compartment, motor to distance between one another to keep eddy-Maxwell's rule, which states:

### Torque Converter

### Look

### F-3 16 Volt Torbo Battery

Air conditioner connected and energized by F-27-F-28. S.D. to reduced A.C. energy battery charged by D.C. to D.C. rectories by F-12 D.C. Geno. From 250V to 112V+/−by auto-volt-regulator, controlled.

Power steering mechanically connected to F-10-F-29 power breaks.

Safety Design Concern and Applications

### Controller Systems Designed to It's Applications, Protecting Eleqtrogine (S.C.E.P.S.) Electronically Engineered to It's Applications.

1. Impact collision cut off switch.
2. Rollover cut off system switch.
3. Circuit breaker.
4. Safety interlocks.
5. Main contactor.
6. D.C. to D.C. converter to maintain F-3 battery.
7. Safety fuses.
8. Design for heavy current and (E.M.F.).
9. Shunt, fused-resisters, coils, capacitor.
10. G.F.I.C. and low-(E.M.F.) low current instrumentation system.
11. Heat sensors, cooling fans, compartment ventilation during operations, dust and moisture free in tamper proof motor compartment.
12. Ground Code N.E.C. Floating Propulsion System.
13. F-3 grounded to auto frame as per factory.
14. Design instrument console with necessary gauges voice to.

### State of the Arts

The Controller: Overview. 188 solid state controllers, controller solution: 207 charging solutions: EV's electrical systems. E.V. Conversion: Solutions.

What is needed? E.V. Controller that can deliver the smooth range of control that is normally associated with the accelerator pedal of internal combustion engine vehicles. Eleqtrogine acceleration is to mimic the I.C. vehicle from starting key-battery F-3 to continue synergistically with the systems. Have controls set in both entities and calibrated. Preset to: A.C. system to P.U. idle at 8 to 1000 RPM. This will hold A.C. in place ready to give accelerator the Dynamo Torque to move the vehicle. While the A.C. holding in place, F-18, D.C. portion of Eleqtrogine. The D.C. along is in place as well. The D.C. portion of the entity may be automatically set at 1.5K RPM. Hold in tandem with F-10 A.C. entity, which is idling at 8.0K to 1.0K RPM. Now should be in synch with each other. Now as the demand for more energy from F-18 D.C. portion of its entity programmed to increase at the demand coming from the A.C. F-10. Now when all of potential HP of 150 to 170 spike HP at about and after F-14, automatic transmission he finished shifting its and all sequence, in the full drive position. 50 to 70 MPH at a RPM of perhaps 4500 to 6000 RPM decrease to a cruising speed at half of the RPM of the numbers given above. Running smoothly throughout the whole system, quietly and in control.

Part of Actions. F-7 Driving: The New Eleqtrogine puts on a voiced driving timer that resets after parked and manual time extender to be used when caught in heavy, slow moving or stopped traffic. With a warning to the driver that time is running out 10 minutes prior. The Eleqtrogine to communicate with the driver of the vehicle by voice or signals or both. Such as voice saying ignition. System is online. You may drive. Repeat after engaging deterrent part of the system, when you press lights, voice lights on or lights off, heater on, A.C. on, A.C. off.

What I claim as my interlectual property is as follows:

1. The new Eleqtrogine (S.C.E.P.S.) that mimics the Internal Combustion Engine with respect to Power and Performance like the I.C.E. dependent on an outside Energy source to start the I.C.E. Eleqtrogine is also dependent on an outside source, The F-3, to start the system. F-3 (P.F.) 89±% delivery 12 D.C.V.A. to F-10A ignition coil (P.F.) 98% 2.0K. R.P.M.'s mechanical energy creating a spike at F-12 of 200 D.C.V.A. (P.F.) 88%±D.C.V.A. directed at F-24 170 D.C.V.A. 170=38H.P. (PF) 68%±. This 68% is excessive H.P. needed to convert into Electrical energy (F-27) 600 A.C.V.A. in unity (F.P.F.) controlled 45% to a constant 38%±as required by Applications and Design and (P.F.) needed F-27 constant torque to carry the System to a smooth conclusion at 1.8 K.R. P. M. converting 1.8.K.R. P.M. to a higher level of A.C.V.A. pre-programmed and controlled Variable Torque as required of the system and answer to it demand with ease and efficiency. F-10 is supported by the Synergistic System Controls in Synch L.C.D.

2. Eleqtrogine (S.C.E.P.S.) is on a timer program that is preset for local driving. This length of time is set at two hours and resets itself after being parked. There are two other settings. One is for short distance driving for short distance driving for not more than one hour. Another setting is for three hours. The other setting for long distance driving is for eight hours or more. This is part of the on-board Computer Control system and can be addressed by the vehicle operator. For example, during heavy traffic the driver can reset the timer to allow for the extra time it takes to navigate through heavy traffic periods. A special timer is set at a default of eight hours with a two hour extension for a total of ten hours. For city driving, it is set for six hours and is reset after the vehicle has been parked.

3. Eleqtrogine (S.C.E.P.S.): True Power and Power Factor: N.E.C. Inductance and Reactance concerned with the properties of alternating F-27 current. Ohm's law Applicable to A.C. circuits which have Resistive loads require A.C. calculations. Ohm's Law×L=2 Π fL. XL=inductive reactance in Ohm's. f=frequency in hertz. L=inductance in henrys. The changes of value and directions of current in turn produce effects. They give A.C. most valuable properties and produce many curious complications, current and voltage sine waves in an entirely resistive circuit A.C. circuit with inductance and Phase Angle. Watt meters read only true power. Voltage times current is apparent power. Volt-Amperes (VA) Kilovolt-Amperes (K.V.A.)=applied Voltage time amperes, and KVA is VA/1000 WITH 100% Power Factor (P.F.). VA will be the same as (w) and KVA=(Kw) a 100% (P.F.) termed Unity (P.F.) N.E.C. Unity (P.F.) VA×PF=(W) and KVA×PF=Kw. Transformer Fact, losses must be considered. Applications classes N.E.M.A. and ANSI Insulation classes are: 105° C.=class A 130° C. Rise-B, 155° C. Rise-Class F, 180° C. Rise-Class H. Oil-filled; dry type: optional. System has a minimal Default of plus and/or minus of (P.F.) to be calculated at the source and factored into its applications and designing stage.
